(19) United States
(12) Patent Application Publication
(10) Pub. No.: US 2017/0293678 A1
(43) Pub. Date: Oct. 12, 2017

(54) ADAPTIVE REDO FOR TRACE TEXT INPUT

(71) Applicant: Nuance Communications, Inc., Burlington, MA (US)

(72) Inventors: Donni McCray, Burlington, MA (US); Brian Yee, Burlington, MA (US)

(21) Appl. No.: 15/095,817

(22) Filed: Apr. 11, 2016

(51) Int. Cl. G06F 17/30; G06F 3/0488

(52) U.S. Cl. CPC G06F 17/30684; G06F 3/04886; G06F 17/30696

(57) ABSTRACT

Disclosed herein is an adaptive redo technology for trace text input via a virtual keyboard, including systems and methods for adaptively modifying the top word suggestion after a user deletes a word and traces a pattern recognized as the same word. An adaptive redo system can recognize that the user has just rejected the default word it is about to present, and instead present an alternative candidate. As a result, the user can proceed without having to re-delete the same rejected word a second time. A text input system with adaptive redo can recognize when a redo trace matches a previous, deleted trace without needing to check the similarity of traces themselves or the similarity of any features of a trace path, reducing the computational requirements needed to improve text recognition after a user deletes and reenters a word.

### BACKGROUND

As smartphones, tablet computers, touchscreen appliances, and other touch-enabled devices grow in popularity, text entry on virtual keyboards becomes ubiquitous. Users of such electronic devices enter billions of text messages each year, in addition to authoring emails, instant messages, Tweets, status updates, blog entries, notes, forms, and all manner of other documents and communications. As demand for virtual keyboard text entry increases, software and hardware developers are challenged to provide reliable, efficient, and convenient text entry features in devices of varying processing power, size, and input interfaces. In some cases, text entry systems allow a user to enter text by tracing a path across the keys of a virtual keyboard. By various means, such text entry systems recognize a word that the user intended from the trace input.

### BRIEF DESCRIPTION OF THE DRAWINGS

FIG. 1 is a block diagram showing some of the components typically incorporated in computer systems and other devices on which adaptive redo for trace text input can be implemented.

FIG. 2 is a system diagram illustrating an example of a computing environment in which an adaptive redo system for trace text input can be utilized.

FIG. 3 is a data flow diagram illustrating logical relationships among adaptive redo components in accordance with some embodiments.

FIGS. 4A and 4B are display diagrams illustrating adaptive redo for trace text input in accordance with an embodiment.

FIG. 5 is a flow diagram illustrating a process for a computer system to provide adaptive redo for trace text input in accordance with an embodiment.

FIG. 6 is a schematic diagram illustrating ordered lists of word suggestions in accordance with an embodiment.

### DETAILED DESCRIPTION

### Overview

When a user traces a path on a virtual keyboard (e.g., using a Swype® or XT9® text entry interface in a mobile computing device), the trace text entry system sometimes recognizes a word that the user did not intend. For example, errors can creep in to a user's trace input if the user is moving quickly or entering text casually or without fully concentrating on the trace. If the user cuts a corner a little too sharply, overshoots a letter slightly, starts or finishes a trace on the wrong key, or shifts a word pattern a bit to one side, the text entry system may not correctly identify the user's desired word. Moreover, some words have naturally similar or even identical trace patterns on a standard QWERTY keyboard, such as “our” and “or”; “tip” and “top”; “toast” and “today”; or “purpose” and “propose.” Because some trace paths do not unambiguously correspond to exactly one word, text entry systems sometimes have to guess, and can guess wrong. A user who wants to tell her friends that she is getting “seated” at the theater may alarm them if she instead writes that she is getting “arrested” at the theater.

Users employ various strategies when a trace text input system misrecognizes the user's intended word. The user can, for example, prompt the input system to provide an alternate word choice. Commonly, though, the user often simply deletes the input and/or the associated default match, and then tries to retrace the desired word. Redoing it in the same way, however, typically results in the same default, incorrect match. This interrupts the user's text entry flow. To exit the redo loop, the user may need to slow down to trace out the desired word more deliberately, or even type out the desired word letter-by-letter. Users find this frustrating.

The inventors have recognized this issue and realized how conventional trace text input systems can be improved with an adaptation to incorporate user feedback, raising the accuracy of word suggestions, preventing redo loops, and reducing user frustration, and thereby improving the speed of trace text input and editing via a virtual keyboard.

Disclosed herein is an adaptive redo technology for trace text input, including systems and methods for adaptively modifying the top word suggestion after a user deletes a word and traces a pattern recognized as the same word. In various embodiments, in contrast to conventional trace text input recognition systems, an adaptive redo system can recognize that the user has just rejected the default word it is about to present, and instead present an alternative candidate. For example, if the theater-goer above accidentally traced the word “arrested,” saw her mistake and deleted it, then traced the same pattern again, an adaptive redo system in accordance with the present disclosure would insert the word “seated” instead of reinserting the deleted word “arrested.”

In various embodiments of the disclosure, adaptive redo recognizes when a redo trace matches a previous, deleted trace, and changes the default word suggestion to avoid presenting the deleted word if another suggestion is also likely. For example, in one scenario a user is entering text into a text buffer (e.g., a text message, document, or field) via trace input. After the user enters a trace path, a text recognition system generates, and may present, a list of ranked matches, with the top match inserted into the text buffer as the default match. The user, who rejects the default word, taps delete, which removes the default match from the buffer and may also remove the list. The adaptive redo system, however, records the deleted word and can also save the list associated with it. Next, the user enters a new trace path that results in the same top candidate. Before the text recognition system presents the same default match again, however, the adaptive redo system detects that the retraced word matches the deleted word. It modifies the list of potential words generated from the new trace path by demoting the default candidate and promoting an alternative candidate. The alternative is then offered as the default. The text recognition system inserts the alternative word in the text buffer. As a result, the user can proceed without having to re-delete the same rejected word a second time.

### DESCRIPTION OF FIGURES

The following description provides certain specific details of the illustrated examples. One skilled in the relevant art will understand, however, that the technology can be practiced without many of these details. Likewise, one skilled in the relevant art will also understand that the technology can include many other obvious features not described in detail herein. Additionally, some well-known structures or functions may not be shown or described in detail below, to avoid unnecessarily obscuring the relevant descriptions of the various examples.

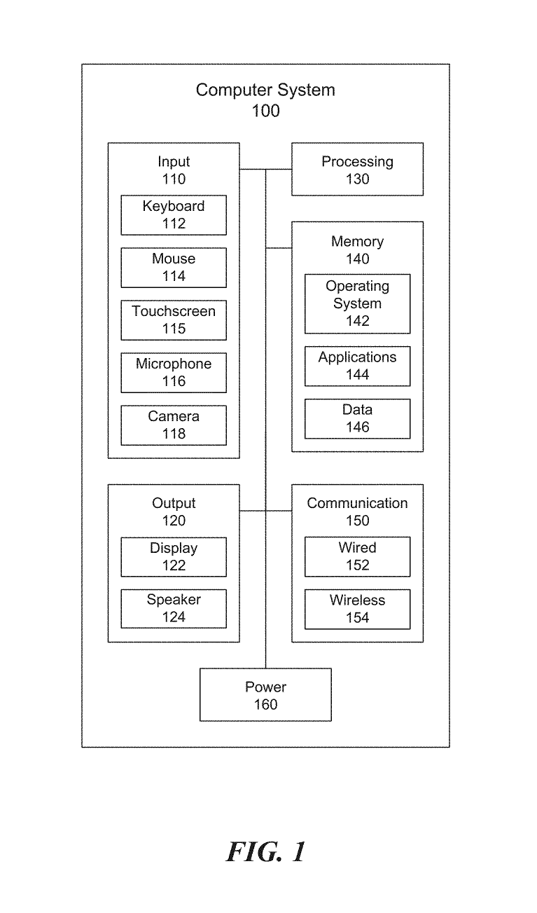

FIG. 1 is a block diagram showing some of the components typically incorporated in computing systems and other devices on which a system that provides word suggestions using adaptive redo can be implemented. In the illustrated embodiment, the computer system 100 includes a processing component 130 that controls operation of the computer system 100 in accordance with computer-readable instructions stored in memory 140. The processing component 130 may be any logic processing unit, such as one or more central processing units (CPUs), graphics processing units (GPUs), digital signal processors (DSPs), field-programmable gate arrays (FPGAs), application-specific integrated circuits (ASICs), etc. The processing component 130 may be a single processing unit or multiple processing units in an electronic device or distributed across multiple devices. Aspects of the system can be embodied in a special purpose computing device or data processor that is specifically programmed, configured, or constructed to perform one or more of the computer-executable instructions explained in detail herein. Aspects can also be practiced in distributed computing environments in which functions are performed by local and/or remote processing devices that are linked through a communications network, such as a local area network (LAN), wide area network (WAN), or the Internet.

The processing component 130 is connected to memory 140, which can include a combination of temporary and/or permanent storage, and both read-only memory (ROM) and writable memory (e.g., random access memory or RAM, CPU registers, and on-chip cache memories), writable non-volatile memory such as flash memory or other solid-state memory, hard drives, removable media, magnetically or optically readable discs and/or tapes, nanotechnology memory, synthetic biological memory, and so forth. A memory is not a propagating signal divorced from underlying hardware; thus, a memory and a computer-readable storage medium do not refer to a transitory propagating signal per se. The memory 140 includes data storage that contains programs, software, and information, such as an operating system 142, application programs 144, and data 146. Computer system 100 operating systems 142 can include, for example, Windows®, Linux®, Android™, iOS®, and/or an embedded real-time operating system. The application programs 144 and data 146 can include software and databases—including data structures, database records, other data tables, etc.—configured to control computer system 100 components, process information (to, e.g., optimize program code data), communicate and exchange data and information with remote computers and other devices, etc. In a distributed computing environment, program modules and data can be located in both local and remote memory storage devices.

In some embodiments, the memory 140 includes program memory that contains programs and software, and data memory that includes configuration data, settings, preferences, files, documents, etc. that may be accessed by instructions from the program memory or by a component of the computing system 100. Program memory can include modules of the operating system 142 and application programs 144, such as a language system and input method editor software for managing user input according to the disclosed technology, and communication software for transmitting and receiving data by various channels and protocols via the communication components 150.

The computer system 100 can include input components 110 that receive input from user interactions and provide input to the processor 130, typically mediated by a hardware controller that interprets the raw signals received from the input device and communicates the information to the processor 130 using a known communication protocol. Examples of an input component 110 include a keyboard 112 (with physical or virtual keys), a pointing device (such as a mouse 114, joystick, dial, or eye tracking device), a touchscreen 115 that detects contact events (e.g., when it is touched by a user), a microphone 116 that receives audio input (e.g., for systems implementing speech recognition as a method of input by the user), and a camera 118 for photograph and/or video capture. The computer system 100 can also include various other input components 110 such as GPS or other location determination sensors, motion sensors, wearable input devices with accelerometers (e.g. wearable glove-type or head-mounted input devices), biometric sensors (e.g., a fingerprint sensor), light sensors (e.g., an infrared sensor), card readers (e.g., a magnetic stripe reader or a memory card reader), and so on.

The processor 130 can also be connected to one or more various output components 120, e.g., directly or via a hardware controller. The output devices can include a display 122 on which text and graphics are displayed. The display 122 can be, for example, an LCD, LED, or OLED display screen (such as a desktop computer screen, handheld device screen, or television screen), an e-ink display, a projected display (such as a heads-up display device), and/or a display integrated with a touchscreen 115 that serves as an input device as well as an output device that provides graphical and textual visual feedback to the user. The output devices can also include a speaker 124 for playing audio signals, haptic feedback devices for tactile output such as vibration, etc. In some embodiments, the speaker 124 and the microphone 116 are implemented by a combined audio input-output device.

In the illustrated embodiment, the computer system 100 further includes one or more communication components 150. The communication components can include, for example, a wired network connection 152 (e.g., one or more of an Ethernet port, cable modem, FireWire cable, Lightning connector, universal serial bus (USB) port, etc.) and/or a wireless transceiver 154 (e.g., one or more of a Wi-Fi transceiver; Bluetooth transceiver; near-field communication (NFC) device; wireless modem or cellular radio utilizing GSM, CDMA, 3G and/or 4G technologies; etc.). The communication components 150 are suitable for communication between the computer system 100 and other local and/or remote computing devices, directly via a wired or wireless peer-to-peer connection and/or indirectly via a communication link and networking hardware, such as switches, routers, repeaters, electrical cables and optical fibers, light emitters and receivers, radio transmitters and receivers, and the like (which can include the Internet, a public or private intranet, a local or extended Wi-Fi network, cell towers, the plain old telephone system (POTS), etc.). The computer system 100 further includes power 260, which can include battery power and/or facility power for operation of the various electrical components associated with the computer system 100.

FIG. 1 and the discussion herein provide a brief, general description of a suitable computing environment in which a system providing adaptive redo can be implemented. Although not required, aspects of the system are described in the general context of computer-executable instructions, such as routines executed by a general-purpose computer, e.g., a mobile device, a server computer, or a personal computer. Those skilled in the relevant art will appreciate that the system can be practiced using other communications, data processing, or computer system configurations, e.g., handheld devices (including tablet computers, personal digital assistants (PDAs), and mobile phones), laptop computers, wearable computers, vehicle-based computers, multi-processor systems, microprocessor-based consumer electronics, set-top boxes, network appliances, mini-computers, mainframe computers, virtual computing platforms, distributed computing environments that include any of the above systems or devices, etc. The terms “computer” and “electronic device” are generally used interchangeably herein, and refer to any such data processing devices and systems. While computer systems configured as described above are typically used to support the operation of a system implementing adaptive redo, one of ordinary skill in the art will appreciate that embodiments may be implemented using devices of various types and configurations, and having various components.

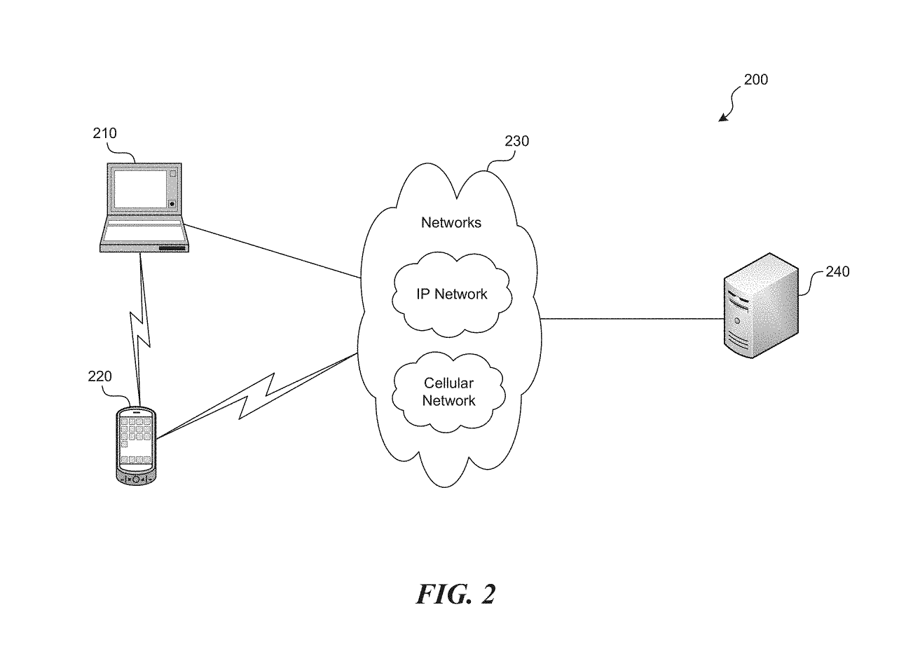

FIG. 2 is a system diagram illustrating an example of a computing environment 200 in which an adaptive redo system for trace text input can be utilized. As illustrated in FIG. 2, an adaptive redo system can operate on various computing devices, such as a computer 210, mobile device 220 (e.g., a mobile phone, tablet computer, mobile media device, mobile gaming device, wearable computer, etc.), and other devices capable of receiving user inputs (e.g., such as a set-top box or vehicle-based computer). Each of these devices can include various input mechanisms (e.g., microphones, keypads, cameras, and/or touch screens) to receive user interactions (e.g., voice, text, gesture, and/or handwriting inputs). These computing devices can communicate through one or more wired or wireless, public or private, networks 230 (including, e.g., different networks, channels, and protocols) with each other and with a system 240 that, e.g., coordinates language model data structure information across user devices and/or performs computations regarding word suggestions. System 240 can be maintained in a cloud-based environment or other distributed server-client system. As described herein, user input (e.g., trace input via a virtual keyboard) can be communicated between devices 210 and 220 and/or to the system 240. In addition, information about the user or the user's device(s) 210 and 220 (e.g., the current and/or past location of the device(s), words suggested, selected, and/or deleted on each device, device characteristics, and user preferences and interests) can be communicated to the system 240. In some embodiments, some or all of the system 240 is implemented in user computing devices such as devices 210 and 220.

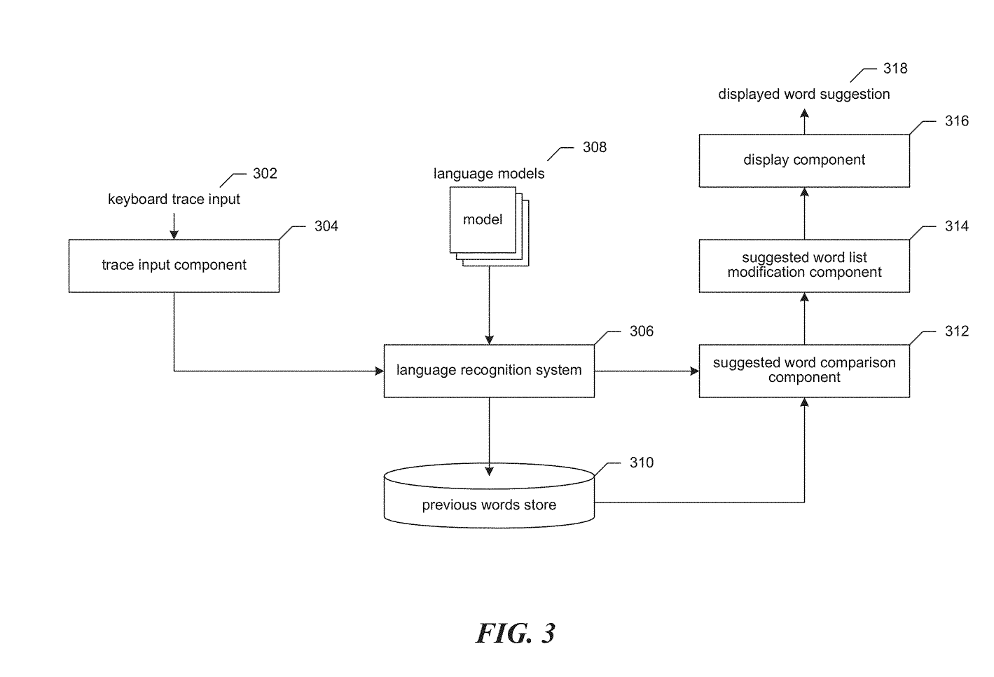

FIG. 3 is a data flow diagram illustrating logical relationships among adaptive redo components in accordance with some embodiments. In various embodiments, a computing system such as the computer system 100 of FIG. 1 (and/or one or more other processing devices operably connectable to the computer system, such as a remote computing server) can implement the adaptive redo components and the data flows depicted in FIG. 3. In the illustrated embodiment, keyboard trace input 302 is received by a trace input component 304. In some embodiments, the trace input component 304 is part of a virtual keyboard system or an input method editor that runs whenever an input field (for text, speech, handwriting, etc.) is active. Examples of input method editors include, e.g., a Swype® or XT9® text entry interface in a mobile computing device.

In the illustrated embodiment, the trace input component 304 is connected to a language recognition system 306 component. The language recognition system 306 is configured to interpret the keyboard trace input 302 to identify potential words that the user may have intended to enter. The language recognition system 306 may be incorporated into an input method editor. Alternatively, the adaptive redo system may operate in conjunction with a separate language recognition system 306 or may be integrated with the language recognition system 306.

The language recognition system 306, in accordance with various embodiments, is connected to one or more language models 308. A language model 308 includes, for example, a data structure (e.g., a list, array, table, or hash map) for words and/or n-grams (i.e., sets of n words, such as three-word trigrams) based on general or individual user language use (e.g., in a particular language and/or context). For example, a language model 308 can store words (and/or potential word candidates), contextual information related to words and/or user input, information regarding, e.g., word probability, recency, and/or frequency of use, gestures mapped to words, information about user selection or rejection of word suggestions, etc.

The illustrated embodiment shows a previous words store 310 that stores words that the language recognition system 306 previously suggested, including words that the user deleted after the language recognition system 306 suggested them. In some embodiments, the previous words store 310 is incorporated in the language recognition system 306 or a language model 308. In some embodiments, the previous words store 310 maintains a record of substantially all word suggestions in an active document or text field. In some embodiments, the previous words store 310 stores, for each recognized and inserted word, a set of additional possible word suggestions that the language recognition system 306 generated, whether or not the additional suggestions were displayed to the user.

In some embodiments, the previous words store 310 functions as a deleted words store, storing only words that the user deleted, or only the last word that the user deleted. In some embodiments, the previous words store 310 includes words that the user deleted regardless of their source, including words not associated with suggestions from the language recognition system 306, such as words entered via letter-by-letter tap entry or cut-and-paste entry.

A suggested word comparison component 312 connects to both the language recognition system 306 and the previous words store 310. The suggested word comparison component 312 is configured to compare a previous word (from the previous words store 310) that the user deleted to a current highest-ranked word suggestion (from the language recognition system 306). In some embodiments, the suggested word comparison component 312 compares two sets of words, e.g., a first word suggestion list associated with a previous input trace, including the word suggestion that the user deleted, and a second word suggestion list associated with the current keyboard trace input 302. The suggested word comparison component 312 is configured to determine whether the previous word that the user deleted at a particular point in the text matches the current top-ranked word that the language recognition system 306 would suggest to the user at approximately the same point in the text. In some embodiments, the suggested word comparison component 312 is further configured to determine whether additional words from the first (previous) word suggestion list match words in the second (current) word suggestion list, indicating whether the current keyboard trace input 302 is substantially similar to the user's previous keyboard trace input.

Using the comparison information from the suggested word comparison component 312, a suggested word list modification component 314 can change the top suggested word. For example, if the top word suggestion from the language recognition system 306 is the same word that the user deleted, the suggested word list modification component 314 can demote that word and promote another word (e.g., the second-most-likely candidate) to the top position. The suggested word list modification component 314 can thus modify the suggested word list before a display component 316 displays the top word suggestion.

After the suggested word list modification component 314 modifies, if necessary, the list of potential words to suggest, the display component 316 displays the highest word suggestion in the list. In various embodiments, the display component 316 inserts the top word into the text so that the user can continue with text entry without stopping to choose a word. In some embodiments, the display component 316 displays a list of word suggestions (e.g., in addition to the inserted word) for the user to choose from.

In various embodiments of the present disclosure, text input adaptive redo components such as those described above can ensure that after the user deletes an incorrect word suggestion and redoes similar keyboard trace input, a text recognition system will suggest a word other than the incorrect word that the user just deleted.

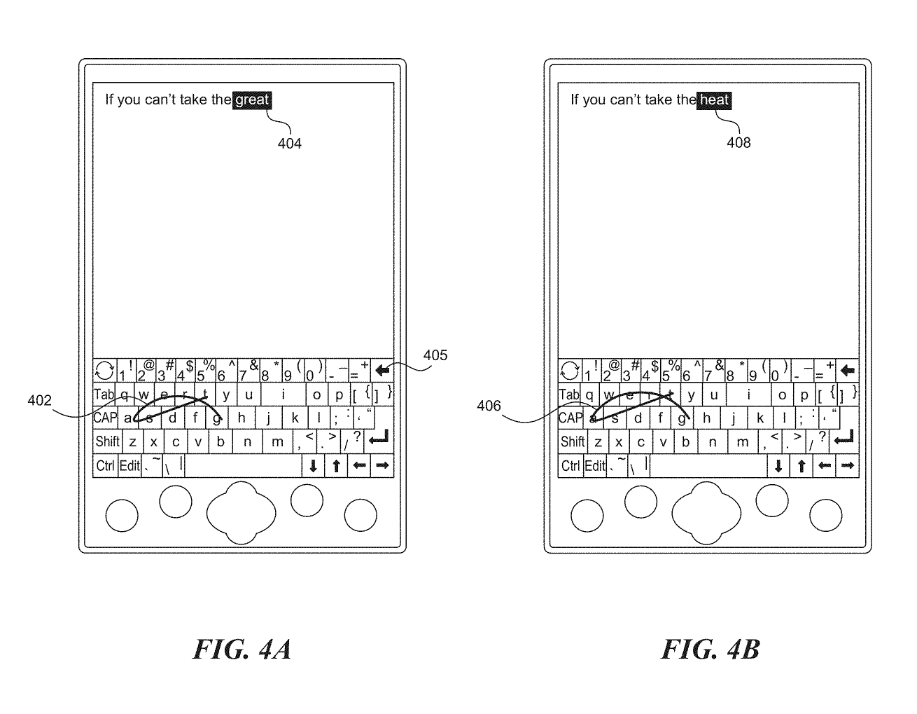

FIGS. 4A and 4B are display diagrams illustrating adaptive redo for trace text input in accordance with an embodiment. In a common scenario when a user is entering text via paths traced on a virtual keyboard system, the user deletes a misrecognized word, then retraces a similar path, expecting the system to recognize the user's intended word instead. In the example illustrated in FIGS. 4A and 4B, the user is tracing paths on the keyboard intending to write a sentence such as “If you can't take the heat, get out of the kitchen!”

FIG. 4A illustrates a first keyboard trace input path 402 that a recognition system misinterprets. The user intended to enter the word “heat,” but, for example, started the trace input path 402 slightly to the left of the “H” key. As a result, the system determined that the most likely word corresponding to the trace input path 402 was the word “great” 404, and displayed that highest-ranked or default word suggestion on the screen.

Trace input systems may enable the user to correct the unintended word in a number of ways. For example, the user may have an option to prompt the system to display alternate word suggestions that would include, e.g., the intended word “heat.” In the case illustrated in FIGS. 4A and 4B, however, the user instead decided to delete the unintended word and try again. For example, the user may use the backspace or delete key 405 to remove the word “great” from the screen. The illustrated keyboard trace input system may, for example, accept one tap of the backspace or delete key 405 to delete the result of the last trace (or, e.g., the word or words to the left of the insertion cursor associated with one trace input path). The system may also enable the user to delete a word or words using other input such as a deletion gesture across the keyboard or by shaking the device to undo the last entry.

FIG. 4B illustrates the user's attempt to redo the input after deleting the word “great.” The user entered a second keyboard trace input path 406. The illustrated second keyboard trace input path 406 is substantially similar, though not identical, to the first keyboard trace input path 402 of FIG. 4A. Still intending to enter the word “heat,” the user again started the trace just to the left of the “H” key. The recognition system would thus interpret the user's second keyboard trace input path 406 as most likely corresponding to the word “great” again. In this case, however, the adaptive redo system recognizes that “great” is the same word that the user deleted at this spot in the text. The adaptive redo system therefore demotes the word “great” in the list of suggestions and moves the next-highest-ranked word, “heat,” into the top position. As a result, after the user deleted “great” and redid the input trace, the screen in FIG. 4B displays the word “heat” 408 as the user intended.

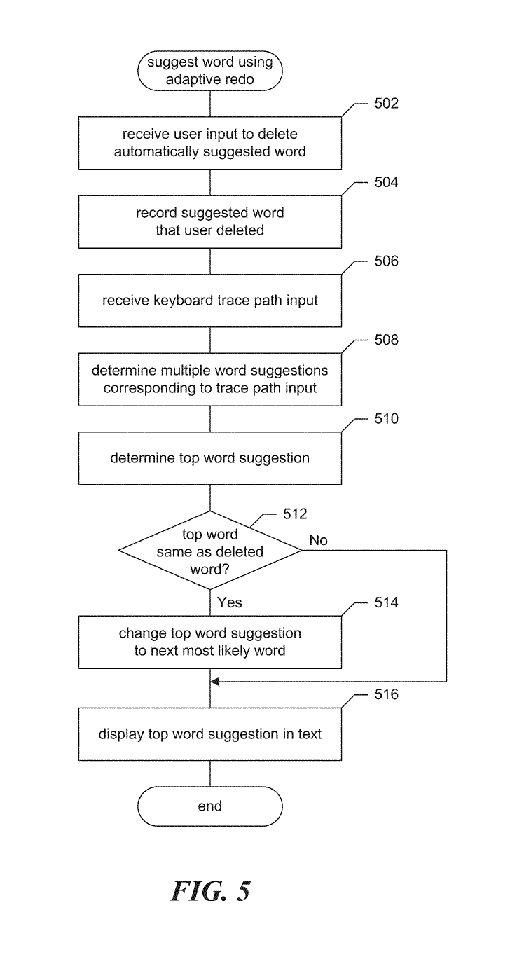

FIG. 5 is a flow diagram illustrating a process for a computer system (e.g., the computing system 100 of FIG. 1) to provide adaptive redo for trace text input in accordance with an embodiment. In various embodiments, the computer system receives a user's keyboard trace to input text, and from the keyboard trace input recognizes a word that the user did not intend; the user deletes the incorrectly recognized word; and then the user traces a similar path on the keyboard, redoing the deleted word. Accordingly, the process illustrated in FIG. 5 is responsible for adaptively providing word suggestions in light of the user's deletion and redo trace input, reducing the likelihood that the system will present the same user-rejected word and increasing the likelihood that it will present the user's intended word. An adaptive redo system can thus enable improved trace text entry speed while using the user's explicit inputs to determine the user's implicit intent.

The process of FIG. 5 begins after the system has received user input via a trace path on a virtual keyboard, has recognized one or more potential word suggestions corresponding to the user input, and has inserted a word into the user's text (e.g., a text entry field or application). In various embodiments, the system inserts the highest likelihood word candidate, based on factors such as the path or shape of the trace, the context (e.g., preceding words), the typical frequency of each suggested word, etc. Examples of such a word recognition system may be found in commonly assigned U.S. Pat. Nos. 7,098,896, 7,453,439, and 7,382,358, each entitled “System and method for continuous stroke word-based text input”; U.S. Pat. No. 7,542,029, entitled “System and method for a user interface for text editing and menu selection”; U.S. Pat. No. 7,706,616, entitled “System and method for recognizing word patterns in a very large vocabulary based on a virtual keyboard layout”; and U.S. Pat. No. 9,104,312, entitled “Multimodal text input system, such as for use with touch screens on mobile phones”; each of which is hereby incorporated by reference in its entirety.

In block 502, the system receives user input to delete a word, such as an automatically suggested and inserted word. In some embodiments, the system interprets a single backspace key tap or defined deletion gesture as a command to delete the word inserted in response to the last user trace input. In some embodiments, if the user has placed the insertion cursor after a word or phrase within the text that was previously recognized and inserted, the system interprets the deletion input as a command to delete the word or phrase to the left of the cursor. In some embodiments, the system recognizes an “undo” action or command (e.g., via a menu selection, a hotkey, a key or button press, or other input such as shaking a mobile device) as input to delete the last-entered word. In some embodiments, the system recognizes user action to select the unintended output word and overwrite it with a new keyboard trace path as a simultaneous deletion and redo of the selected word.

In block 504, the system records the word that the user deleted as possibly incorrectly suggested and inserted. For example, the system can save the deleted word and set a flag identifying it as a word not to immediately re-suggest. In various embodiments, when the system maintains a list of word suggestions recognized from the last trace input, recording the word that the user deleted includes recording the list of suggestions, or a set of entries from the list (e.g., the five most likely word suggestions). When the user deletes a word in block 502, the system caches or stores the recognized word list or a representation of the recognized word list before deletion. For example, the system can maintain a pointer to a data structure containing or referencing the previously suggested word. In some embodiments, if deleting the word also causes its associated word suggestion list to be deleted, the system temporarily intercepts or withholds or delays issuing a signal that the word was deleted, allowing the adaptive redo process to access (e.g., read and/or copy) the list of word suggestions.

In some cases, a user can enter multiple words in a single path (e.g., tracing a path through the space bar to separate words, or a path that is recognized as a multi-word phrase). In some embodiments, the system maintains lists of word history back several words. In some embodiments, the system maintains a list of word suggestions recognized from a set of recent trace inputs or from substantially all trace inputs in the user's text, enabling adaptive redo for previous words in recognized text in addition to the last word entered.

In some embodiments, the system enables adaptive redo for any deleted word, including words for which no suggestion was originally provided. For example, if the user pastes a block of text into a document or text entry field, deletes an incorrect word, and then enters a new keyboard trace path to replace the deleted word, the system likely does not have a list of prior word suggestions associated with the deleted word. The system can, however, recognize the deleted word itself and can therefore operate as described herein to ensure that the new keyboard trace path does not reinsert the same word.

In block 506, the system (e.g., the trace input component 304 of FIG. 3) receives keyboard trace path input. In some embodiments, the system verifies that the input is a trace, as opposed to, e.g., a word explicitly tapped out letter-by-letter, a word expanded from an abbreviation, or a word inserted via a cut-and-paste action, for which the system may not generate word suggestions. In some embodiments, the system does not enable adaptive redo on very short trace paths, because such short paths may have been intended as tap input. For example, the system can include a threshold for activating adaptive redo based on word length (e.g., words that are longer than two or three characters) or based on trace input path length.

In block 508, the system (e.g., the language recognition system 306 component of FIG. 3) generates a set of multiple potential word suggestions determined to correspond to the keyboard trace path input received in block 506. In various embodiments, the system identifies words from a language model (e.g., the language models 308 of FIG. 3) that have letters matching keys associated with features of the keyboard trace path input, and determines a probability for each word based on the quality of the match, the input context (e.g., preceding words, the active application, the user's typical vocabulary, etc.), word frequency statistics, and so on. In block 510, the system determines a top word suggestion, such as the word identified by the language recognition system as having the highest probability of being the user's intended word based on the user's keyboard trace path input.

In decision block 512, the system determines whether the top word suggestion determined in block 510 is the same word as the deleted word, in this case the previous automatically suggested and inserted word that the user deleted in block 504. For example, if the top word suggestion is the saved word (and perhaps if a flag to enable adaptive redo for the saved word is set), then the system can avoid re-suggesting that word. By comparing whether the same word is in the top position, the system can identify that the user's post-deletion trace path was similar to the previous trace path, without needing to check the similarity of traces themselves or the similarity of any features of a trace path. If the top word suggestion is not the same as the previously entered and user-deleted word, then the user's second trace input was sufficiently different to generate a different word suggestion, and the process continues in block 516. If, on the other hand, the top word suggestion matches the previously entered word, then the process continues in block 514.

In some embodiments, the system checks for similarity of more than one word. For example, the system may not only verify that the top word suggestion matches the deleted word, but also compare additional words from the lists of suggested words generated from the previous and redo traces. In some embodiments, the system compares, e.g., two or five words, such as position-by-position (are both the first and the second suggested words in each list identical?), or without regard to position (does a second word appear in both lists?). In such a system, determining whether to perform adaptive redo suggestion replacement can be based on a numeric threshold level of similarity, which may be adjustable. For example, an adaptive redo system using a liberal threshold can determine that if two of the same words appear in both the old and new lists, the old and new traces are sufficiently similar to proceed with adaptive redo. As another example, a conservative threshold could require the top five suggestions to be identical, indicating certainty that the user's input trace paths were nearly the same. In some embodiments, the threshold for determining whether to perform adaptive redo is based on comparing probabilities of one or more of the word suggestions.

In block 514, the system has determined (in block 512) that at least the top word suggestion matches the word that the user deleted, so to avoid re-suggesting the deleted word, the system changes the top suggestion by making the second-most-likely word the new top suggestion. The system can accomplish this in various ways, such as by modifying one or more intended word probabilities (e.g., modifying a value representing the likelihood that the top word is the user's intended word); changing the order of the ranked word suggestions; or replacing the top word in the list of ranked word suggestions with the second word. When the system promotes the second suggestion to be the default candidate, the system also demotes the previous top suggestion. The system can apply different demotion strategies to the deleted word. For example, the system can move the demoted suggestion to the second position in the list, swapping the places of the first and second suggestions. Or the system can move the suggestion matching the word that the user deleted lower in the list of suggestions. For example, the system may demote the previous top suggestion below a threshold for presenting it as an alternative suggestion. The system does not completely remove the demoted suggestion from the list because the user might have wanted the originally entered word, accidentally deleted it, and then reentered it. Absence of the most likely traced word from the list of suggestions could be obtrusive and unexpected; accordingly, in various embodiments, the system includes the demoted word in a list of alternative suggestions. Alternatively, in some embodiments the system completely removes the previous top suggestion from the list rather than demoting it within the list.

In block 516, the system displays the top word suggestion in the user's text. In various embodiments, the top word suggestion is provided as a default candidate word that is automatically displayed or inserted in the user's text with no additional action needed if the user moves on to input the next word. Because no additional step is required for the user to choose the new top suggested word instead of the deleted word, the process enables the user to input intended text faster.

In some cases, after the system suggests a new word using adaptive redo, the user makes a second deletion and re-redoes the input trace. For example, the user may enter text via a first trace, delete the first recognized word, re-enter text via a similar second trace (recognized as a different word via adaptive redo), delete the second word, and again enter text via a similar third trace. In some embodiments, after the third trace the system determines what word to suggest based at least in part on the quality of the words in the suggestion list. For example, if the word recognition system generates three candidate words having similar probability scores (e.g., using criteria such as language model frequency, part of speech appropriateness, n-gram analysis, and/or input accuracy scores), the system can determine that all three words are similarly likely. The system can then determine which of the three was not presented as a default suggestion the first and second times, and promote the third word as the default suggestion much as described in block 514 above. On the other hand, if a likelihood score or probability of the third word is much lower than that of the first and second candidates, or below a probability threshold, then rather than making a very unlikely word the default, the system can suggest one of the first two words (e.g., the less recently suggested word or the most probable word).

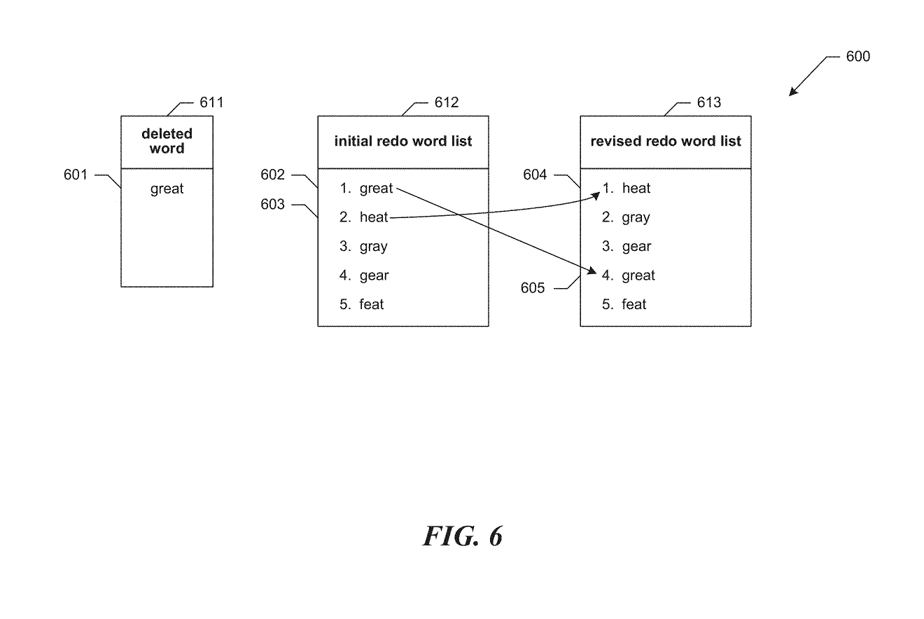

FIG. 6 is a schematic diagram illustrating ordered lists of word suggestions in accordance with an embodiment. The illustrated lists correspond to the scenario illustrated in FIGS. 4A and 4B, in which a user intended to enter the word “heat” but traced a first path that generated the word “great” instead. The user then deleted the misrecognized word “great” and traced a second path that resembled the first path, expecting the system to recognize the user's intended word “heat” on the redo try.

A deleted word list 611 contains the word “great” 601 that the user deleted. In the illustrated embodiment, an adaptive redo system records the deleted word in the deleted word list 611. In some embodiments, the system can also store other word suggestions, if any, that were associated with the deleted word (e.g., a ranked list of potential words generated from user input, including the top-ranked or default word that the system inserted and the user then deleted).

An initial redo word list 612 contains an ordered list of words that a trace input system (e.g., the language recognition system 306 component of FIG. 3) determines are the most likely words corresponding to the user's second trace input path. For example, the path 406 illustrated in FIG. 4B begins within the “G” key of the virtual keyboard and most closely corresponds to the word “great.” In the illustrated initial redo word list 612, the highest ranked word is the word “great” 602. The second-most-likely word, based on the user's input, is the word “heat” 603. Other words (“gray,” “gear,” and “feat) are determined to be less likely candidates and are lower in the initial redo word list 612.

A revised redo word list 613 shows the effect of the adaptive redo system. Because the most likely word corresponding to the user's second trace input path (i.e., “great” 602) matched the deleted word (“great” 601), the adaptive redo system (e.g., the suggested word list modification component 314 of FIG. 3) modified the initial redo word list 612, producing the revised redo word list 613. In the illustrated example, the revised redo word list 613 contains the same words as the initial redo word list 612, in a different order. The second-most-likely word “heat” 603 in the initial redo word list 612 has been promoted to be the top-ranked or default word “heat” 604 in the revised redo word list 613. The highest ranked word “great” 602 in the initial redo word list 612 has been demoted in the revised redo word list 613 to the fourth position “great” 605. As a result, the word “heat” 604 is presented to the user as the top word suggestion, such as by automatically inserting the word “heat” 408 as illustrated in FIG. 4B.

Although the contents and organization of the lists illustrated in FIG. 6 are designed to make them more comprehensible by a human reader, those skilled in the art will appreciate that actual data structures used to store this information can differ from the lists shown in a variety of ways. For example, they can be organized in a different manner (e.g., in multiple different data structures, of various types (e.g., linked lists, arrays, queues, trees, heaps, hash tables, and so on)); can contain more or less information than shown; can be compressed and/or encrypted; etc.

Embodiments operating in some or all of the ways described above provide an adaptive redo text suggestion infrastructure that compares a user-deleted word to its potential replacement, adaptively suggesting an alternative word if the default suggestion matches the deleted word. By comparing deleted and suggested words as described herein, embodiments of the present disclosure can identify similar user keyboard trace input without needing to check the similarity of traces themselves or the similarity of any features of a trace path. An adaptive redo embodiment can thus reduce the computational requirements needed to improve text recognition of user redo input. Accordingly, adaptive redo provides improved word predictions after a user deletes and reenters a word, and thus enables the user to enter text more quickly and naturally.

### CONCLUSION

The above Detailed Description of examples of the disclosure is not intended to be exhaustive or to limit the disclosure to the precise form disclosed above. While specific examples for the disclosure are described above for illustrative purposes, various equivalent adaptations, modifications, and extensions are possible within the scope of the disclosure, as those skilled in the relevant art will recognize. For example, while blocks representing various processes or components are presented in a given order or arrangement herein, alternative embodiments can perform routines or employ systems having processes or components in a different order, and some processes or components can be deleted, moved, added, subdivided, combined, and/or modified to provide alternative or sub combinations. Each of these processes or components can be implemented in a variety of different ways. Also, while processes or components are at times shown in series, these processes or components can instead be performed or implemented in parallel, or can be performed or employed at different times. Further, any specific numbers noted herein are only examples: alternative embodiments can employ differing values or ranges.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the disclosure. Accordingly, the disclosure is not limited except as by the appended claims.

We claim:

1. A method performed by an electronic device to provide adaptive redo for trace text input via a virtual keyboard, the method comprising:
receiving user input to delete a first word from a text buffer displayed by the electronic device;
deleting the first word from the text buffer;
storing, in a data structure, an indication of the deleted first word;
receiving user trace path input via the virtual keyboard to enter text in the text buffer as a replacement for the deleted first word;
generating, based on the user trace path input, ranked word suggestions including a top word suggestion and an alternate word suggestion;
determining, by comparing the top word suggestion and the deleted first word, that the top word suggestion is the same word as the deleted first word; and
displaying the alternate word suggestion in the text buffer instead of the top word suggestion.

2. The method of claim 1 wherein receiving user input to delete the first word comprises receiving a backspace key activation, receiving a defined deletion gesture, receiving a command to undo insertion of the first word, or receiving input to select the first word such that receiving the user trace path input overwrites the first word.

3. The method of claim 1 wherein storing the deleted first word further comprises saving one or more previous word suggestions associated with the deleted first word.

4. The method of claim 3 wherein comparing the top word suggestion and the deleted first word further comprises comparing one or more additional words of the ranked word suggestions to one or more additional words of the previous word suggestions.

5. The method of claim 4, further comprising determining that the ranked word suggestions and the previous word suggestions exceed a threshold level of similarity based at least in part on a number of matching words or on intended word probabilities of matching words.

6. The method of claim 1 wherein displaying the alternate word suggestion in the text buffer instead of the top word suggestion comprises changing an order of the ranked word suggestions.

7. The method of claim 6 wherein changing the order of the ranked word suggestions includes promoting the alternate word suggestion to the top position in the list and demoting or removing the top word suggestion.

8. The method of claim 1 wherein displaying the alternate word suggestion in the text buffer instead of the top word suggestion comprises replacing a word in a list of the ranked word suggestions.

9. The method of claim 1 wherein displaying the alternate word suggestion in the text buffer instead of the top word suggestion comprises modifying an intended word probability of one or more of the ranked word suggestions.

10. The method of claim 1, further comprising:
receiving user input to delete the alternate word suggestion;
receiving, after deletion of the alternate word suggestion, new trace path input via the virtual keyboard to enter text where the alternate word suggestion was deleted from the text buffer;
generating, based on the new user trace path input, new ranked word suggestions including a new top word suggestion and a new alternate word suggestion;
determining that the new top word suggestion is the same word as the deleted first word or the same word as the deleted alternate word suggestion;
determining intended word probability scores of the deleted first word and of the new alternate word suggestion; and
displaying, based at least in part on comparing the intended word probability scores, the deleted first word or the new alternate word suggestion in the text buffer instead of the new top word suggestion.

11. A computer-readable storage medium having contents configured to cause an electronic device to provide adaptive redo for trace text input via a virtual keyboard by:
receiving user input to delete a first word from a text buffer displayed by the electronic device;
deleting the first word from the text buffer;
storing, in a data structure, the deleted first word;
receiving user trace path input via the virtual keyboard to enter text in the text buffer as a replacement for the deleted first word;
generating, based on the user trace path input, ranked word suggestions including a top word suggestion and an alternate word suggestion;
determining, by comparing the top word suggestion and the deleted first word, that the top word suggestion is the same word as the deleted first word; and
displaying the alternate word suggestion in the text buffer instead of the top word suggestion.

12. The computer-readable storage medium of claim 11 wherein storing, in a data structure, the deleted first word comprises maintaining a pointer to a data structure containing or referencing the deleted first word.

13. The computer-readable storage medium of claim 11, further comprising determining that no other user text input was received between the user input to delete the first word and the user trace path input to enter text in the text buffer as a replacement for the deleted first word.

14. The computer-readable storage medium of claim 11 wherein receiving user trace path input via the virtual keyboard to enter text in the text buffer as a replacement for the deleted first word comprises determining that the user trace path input is longer than a threshold path length or determining that the user trace path input corresponds to one or more words longer than a threshold word length.

15. The computer-readable storage medium of claim 11 wherein generating ranked word suggestions including a top word suggestion comprises identifying a word as having the highest probability of being the user's intended word based on the user trace path input.

16. The computer-readable storage medium of claim 11, further comprising displaying a list of word suggestions including the top word suggestion, such that the user can choose to insert the top word suggestion in the text buffer in place of the alternate word suggestion.

17. An adaptive redo system for trace text input via a virtual keyboard in an electronic device, the system comprising:
a previous words store configured to store a user-deleted word;
a trace input component configured to receive trace text input from a user via the virtual keyboard;
a language recognition system component configured to generate a suggested word list of ranked words that correspond to trace text input received by the trace input component;
a suggested word comparison component configured to compare a user-deleted word from the previous words store to a highest-ranked suggested word from a suggested words list generated by the language recognition system component;
a suggested word list modification component configured to, based on whether the suggested word comparison component indicates a match, change the top word in a suggested words list from the highest-ranked word to the second-ranked word; and
a display component configured to display the top word in the modified suggested word list.

18. The system of claim 17 wherein the previous words store is further configured to store a suggested words list associated with a user-deleted word or suggested words lists associated with each of substantially all words in an active document or text field.

19. The system of claim 17 wherein the suggested word comparison component is further configured to compare the contents of two suggested words lists.

20. The system of claim 17 wherein the suggested word list modification component is further configured to demote the highest-ranked word in the suggested words list.
